(19) United States
(12) Patent Application Publication
(10) Pub. No.: US 2020/0097884 A1
(43) Pub. Date: Mar. 26, 2020

(54) User Device For Matching Talented Person With Project, And Computer Program Stored On Computer-Readable Storage Medium

(71) Applicant: Story&Brothers co., Ltd., Busan (KR)

(72) Inventors: Bo Hoon KIM, Gyeonggi-do (KR); Emil Hyunbae ZIN, Gyeonggi-do (KR); Nak Cheon CHOI, Gyeonggi-do (KR); Young Kun LEE, Seoul (KR); Keon KIM, Gyeonggi-do (KR)

(21) Appl. No.: 16/471,870

(22) PCT Filed: Dec. 20, 2017
(86) PCT No.: PCT/KR2017/015098

§ 371 Date: Jun. 20, 2019

(30) Foreign Application Priority Data
Dec. 21, 2016 (KR) 10-2016-0175539

(51) Int. Cl. G06Q 10/06; G06Q 10/10

(52) U.S. Cl. CPC G06Q 10/063112; G06Q 10/10; G06Q 10/063118

(57) ABSTRACT

Disclosed is a computer program stored in a computer readable medium including encoded commands. The computer program includes commands which cause one or more processors of a computer system to execute steps and the steps may include: automatically presenting on a user device a first user interface (UI) configuration for allowing a selection of one of a plurality of indications presented on the user device in response to a program execution request, in which the first UI configuration includes a first indication for receiving profile information of a user, a second indication for receiving project information for a project of a user and a third indication for providing information relating to a project matching rate; automatically presenting on the user device a second UI configuration for receiving the profile information from the user in response to a selection of the first indication displayed; automatically presenting on the user device a third UI configuration for receiving the project information from the user in response to a selection of the second indication displayed; and automatically presenting on the user device a fourth UI configuration for displaying a matching rate of the project between a first user and the project in response to a selection of the third indication displayed, in which the matching rate is calculated based at least in part on one or more first keywords determined from profile information of a first user and one or more second keywords determined from project information of a second user.

### CROSS-REFERENCE TO RELATED APPLICATIONS

This application claims priority to and the benefit of Korean Patent Application No. 10-2016-0175539 filed in the Korean Intellectual Property Office on Dec. 21, 2016, the entire contents of which are incorporated herein by reference.

### TECHNICAL FIELD

The present disclosure relates to a method for matching a talented person with a project, and more particularly, to a method for providing project information with a high matching rate to a talented person and providing talented person information with a high matching rate to a project establisher.

### BACKGROUND ART

With the expansion of IT technology and the dissemination of IT devices, commercialization is possible even only with simple ideas. Moreover, as start-up conditions have improved in response to alternatives to high unemployment rates, the number of people who intend to proceed with a project has increased by opening the project and recruiting persons. Korean Patent No. 10-2015-0046398 suggests a start-up project integration support system.

Meanwhile, it is important to find a suitable manpower to carry out the project in order to develop the project so that the project can be commercialized and to actually commercialize the project.

There is a need in the art to provide a method for matching the talented person with the project.

### SUMMARY OF THE INVENTION

The present disclosure has been made in an effort to provide a method for matching a talented person with a project.

The present disclosure has been made in an effort to provide a method for providing project information with a high matching rate to a talented person and provide talented person information with a high matching rate to a project establisher through a method for matching a talented person with a project.

An exemplary embodiment of the present disclosure provides a computer program stored in a computer readable medium including encoded commands. The computer program includes commands which cause one or more processors of a computer system to execute steps and the steps may include: automatically presenting on a user device a first user interface (UI) configuration for allowing a selection of one of a plurality of indications presented on the user device in response to a program execution request, in which the first UI configuration includes a first indication for receiving profile information of a user, a second indication for receiving project information for a project of a user and a third indication for providing information relating to a project matching rate; automatically presenting on the user device a second UI configuration for receiving the profile information from the user in response to a selection of the first indication displayed; automatically presenting on the user device a third UI configuration for receiving the project information from the user in response to a selection of the second indication displayed; and automatically presenting on the user device a fourth UI configuration for displaying a matching rate of the project between a first user and the project in response to a selection of the third indication displayed, in which the matching rate is calculated based at least in part on one or more first keywords determined from profile information of a first user and one or more second keywords determined from project information of a second user.

Alternatively, the first UI configuration may further include a fourth indication for providing a platform for transmitting and receiving predetermined information between a user whose matching rate with the project exceeds a threshold matching rate and another user related to the project and the steps may further include automatically presenting a fifth UI configuration on the user device in response to a selection of the fourth indication displayed, the fifth UI configuration including at least one of a post upload platform, a chat platform, a messenger platform or a conference call platform.

Alternatively, the fifth UI configuration may be presented in a different format according to different authority determined based on at least one of the matching rate with the project, a participation of a user in the project exceeding the threshold matching rate or performing task in the project of a user exceeding the threshold matching rate.

Alternatively, the second UI configuration and the third UI configuration may display a required input item and a selected input item for the profile information and the project information may separately display information that induces user input to the selected input item and the profile information may include at least one of name information, ID information, gender information, age information, nationality information, education information, residence information, interested word information, retention qualification information, other history information, website usage information or social network system (SNS) information, and the project information may include at least one of core technology information, project outline information, core technology level information of the project, project execution period information or information about a performance personnel required for the project including at least one of the number of the performance personnel and performance group information of the performance personnel.

Alternatively, the second UI configuration and the third UI configuration may include a sixth UI configuration for obtaining at least a portion of the profile information and the project information via at least one of a memory and a network.

Alternatively, the second UI configuration and the third UI configuration may include a seventh UI configuration for presenting profile sub information to obtain at least a portion of the profile information and the project information and an eighth UI configuration for presenting project sub information, and the steps may further include: determining, as the profile information for the user, a selected profile sub information in response to a user selection input for the profile sub information presented in the seventh UI configuration; and determining, as the project information for the user, a selected project sub information in response to a user selection input for project sub information presented in the eighth UI configuration.

Alternatively, the fourth UI configuration may include a fifth indication for receiving feedback on the project from the first user, and the steps may further include automatically presenting at least one of feedback information for the project of the first user or a portion of the profile information of the first user on a device of the second user in response to the selection of the fifth indication displayed.

Alternatively, the fourth UI configuration may include at least one of a sixth indication for receiving feedback for the first user from the second user, and the steps may further include automatically presenting at least one of feedback information for the first user of the second user or a portion of the project information on a device of the first user in response to a selection of the sixth indication displayed.

Alternatively, the steps may include: automatically presenting on the user device a login UI configuration for logging into a program by allowing selection of one of a plurality of indications presented on the user device in response to a program execution request, and the login UI configuration may include a seventh indication for performing a login and an eighth indication for a user's membership subscription to the program, and the login may be performed based in part on at least one of a portion of user's profile information and biometric information of the user.

Another exemplary embodiment of the present disclosure provides a user device. The user device may include: at least one display unit; at least one processor; and a memory configured to store instructions executable by the one or more processors, in which the at least one processor is further configured to: automatically present on a user device a first UI configuration for allowing a selection of one of a plurality of indications presented on the user device in response to a program execution request, in which the first UI configuration includes a first indication for receiving profile information of a user, a second indication for receiving project information for a project of the user and a third indication for providing information relating to a project matching rate; automatically present on the user device a second UI configuration for receiving the profile information from the user in response to a selection of the first indication displayed; automatically present on the user device a third UI configuration for receiving the project information from the user in response to a selection of the second indication displayed; and automatically present on the user device a fourth UI configuration for displaying a matching rate between a first user and the project in response to a selection of the third indication, in which the matching rate is calculated based at least in part on one or more first keywords determined from the profile information of a first user and one or more second keywords determined from the project information of a second user.

According to exemplary embodiments of the present disclosure, a talented person and a project optimized can be matched with each other by an efficient scheme.

According to exemplary embodiments of the present disclosure, project information with a high matching rate can be provided to a talented person and talented person information with a high matching rate can be provided to a project establisher.

### BRIEF DESCRIPTION OF THE DRAWINGS

Some of the exemplary embodiments are illustrated in the accompanying drawings so as to appreciate the aforementioned features of the contents of the present disclosure by a detailed and more concrete description with reference to the following exemplary embodiments. Further, it is intended that like reference numerals in the drawing denote the same or similar function throughout several aspects. However, the accompanying drawings illustrate only specific typical exemplary embodiments of the contents of the present disclosure and are not considered to limit the scope of the present disclosure and it should be noted that other exemplary embodiments having the same effect may be sufficiently recognized.

FIG. 1 is a diagram illustrating a system for matching a talented person with a project according to exemplary embodiments of the present disclosure.

FIG. 2 is a diagram illustrating a configuration diagram of a server for matching a talented person with a project according to exemplary embodiments of the present disclosure.

FIG. 3 is a diagram illustrating a flowchart of creating a user interface for matching a talented person with a project according to exemplary embodiments of the present disclosure.

FIGS. 4 to 15 are exemplary diagrams of a user interface which may be presented onto a user device according to exemplary embodiments of the present disclosure.

FIG. 16 is a diagram illustrating a flowchart of a method for matching a talented person with a project according to exemplary embodiments of the present disclosure.

FIG. 17 is a first conceptual view of a method for matching a talented person with a project according to exemplary embodiments of the present disclosure.

FIG. 18 is a second conceptual view of a method for matching a talented person with a project according to exemplary embodiments of the present disclosure.

FIG. 19 illustrates an operation conceptual view of an application for providing an exemplary method for matching a talented person with a project according to exemplary embodiments of the present disclosure.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among enumerated related items.

In addition, the word “comprises” and/or “comprising” means that the corresponding feature and/or component is present, but it should be appreciated that presence or addition of one or more other features, components, and/or a group thereof is not excluded. Further, when not separately specified or not clear in terms of the context that a singular form is indicated, it should be construed that the singular form generally means “one or more” in the present specification and the claims.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be analyzed within the widest range which is coherent with the principles and new features presented herein.

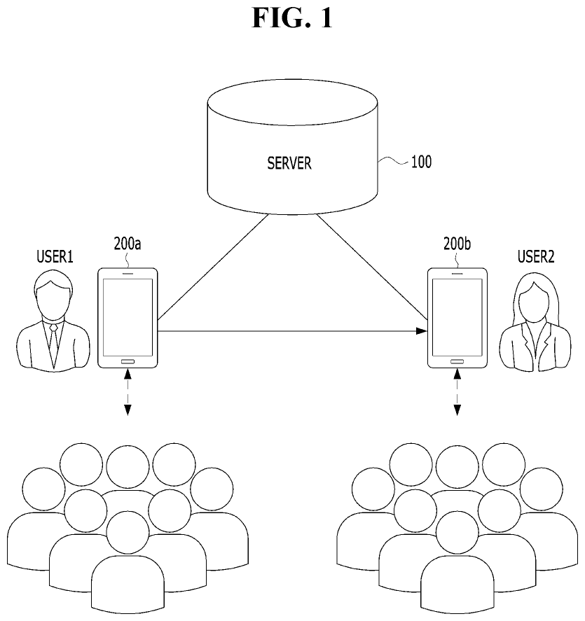

FIG. 1 is a diagram illustrating a system for matching a talented person with a project according to exemplary embodiments of the present disclosure.

A term “first user” used in this specification may refer to a talented person. In addition, a term “second user” used in this specification may refer to a project establisher who establishes the project. As another example, the “first user” may be a participant who is likely to participate in the project and the “second user” may be an organizer who hosts the project. That is, the terms “first user” used in this specification may refer to a user who is likely to participate in the “project” established by the “second user”.

FIG. 1 is a network configuration diagram for a system for matching a talented person with a project according to exemplary embodiments of the present disclosure, which may include a server 100 and one or more user devices 200a and 200b.

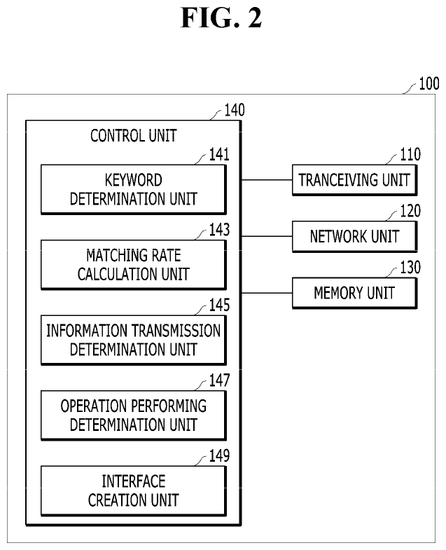

The server 100 according to exemplary embodiments of the present disclosure will be described below with reference to FIG. 2.

In FIG. 1, only a first user device 200a corresponding to the first user and only a second user device 200b corresponding to the second user are illustrated, but this should not be construed as limiting the scope of the present disclosure. The first user device 200a and the second user device 200b which are the terms used in this specification may be collectively referred to as a user device 200.

Here, the user device 200 may include a hand phone, a cellular phone, a wireless communication device, and the like and is not limited thereto. Further, a user device 100 which is a term used in this specification may be a predetermined user device in which a computer program stored in a computer readable medium including commands for providing a system for matching a talented person with a project to be described below is installed.

For example, the user device 200 may be referred to as user equipment (UE), mobile, a PC which may communicate wirelessly, a hand phone, a kiosk, a cellular phone, a cellular, a cellular terminal, a subscriber unit, a subscriber station, a mobile station, a terminal, a remote station, a PDA, a remote terminal, an access terminal, a user terminal, a user agent, a cellular phone, a wireless phone, a session initiation protocol (SIP) phone, a wireless local loop (WLL) station, a portable device having a wireless connection function, a predetermined device which may use a wireless connection mechanism, such as a wireless modem, and the like, but is not limited thereto.

The user device 200 may be referred to as a predetermined device capable of using a wired connection mechanism, such as a wired facsimile, a PC including a wired modem, a wired telephone, a terminal which may communicate by a wired type, or the like, but is not limited thereto.

According to exemplary embodiments of the present disclosure, the user device 200 may include one or more display units, one or more processors, and a memory configured to store commands executable by the one or more processors.

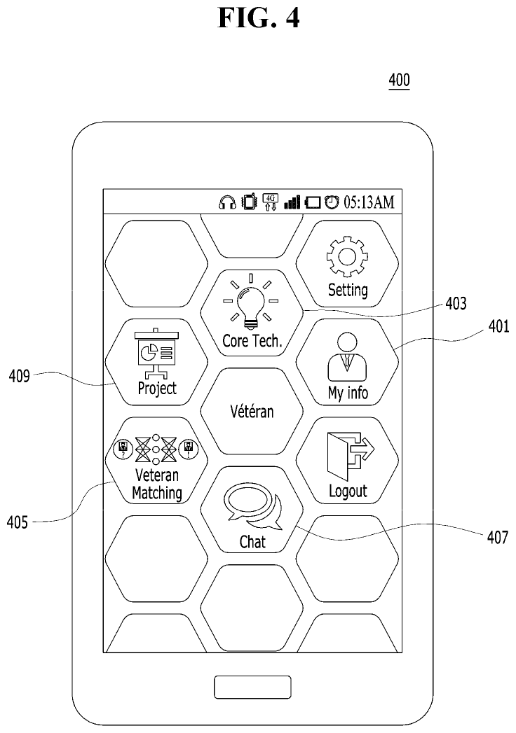

Here, the processor is configured to automatically present on the user device a first UI configuration for allowing selection of one of a plurality of indications presented onto the user device 200 in response to a program execution request. Here, the first UI configuration includes a first indication for receiving profile information of a user, a second indication for receiving project information for the project of the user, and a third indication for providing information related to a project matching rate, and the scope of the present disclosure is not limited thereto. The plurality of indications and UIs will be described below with reference to FIGS. 4 to 15.

According to exemplary embodiments of the present disclosure, a second UI configuration for receiving the profile information from the user may be automatically presented onto the user device 200 in response to the selection of the first indication displayed. Further, a third UI configuration for receiving the project information from the user may be automatically presented onto the user device 200 in response to the selection of the second indication displayed.

A fourth UI configuration may be automatically presented on the user device, which indicates the matching rate of the project with the first user calculated at least partially based on one or more first keywords determined from the profile information of the first user and one or more second keywords determined from the project information of the second user in response to the selection of the third indication displayed. The UI configuration will be described below with reference to FIGS. 4 to 15.

As illustrated in FIG. 1, the server 100 may be connected to one or more user devices 200a and 200b through a network.

The network according to exemplary embodiments of the present disclosure may include a wired/wireless Internet module for network connection. As the wireless Internet technology, wireless LAN (WLAN) (Wi-Fi), wireless broadband (Wibro), world interoperability for microwave access (Wimax), high speed downlink packet access (HSDPA), or the like, may be used. As wired Internet technology, a digital subscriber line (XDSL), fibers to the home (FTTH), power line communication (PLC), or the like may be used.

The network according to exemplary embodiment of the present disclosure includes a short range communication module to transmit/receive data to/from an electronic device which is positioned in a comparatively short range from the user device 200 and includes the short range communication module. As short-range communication technology, Bluetooth, radio frequency identification (RFID), infrared data association (IrDA), ultra wideband (UWB), ZigBee, or the like may be used.

Contents illustrated in FIG. 1 are exemplary figures for describing the method for matching the talented person with the project according to exemplary embodiments of the present disclosure and the present disclosure is not limited thereto.

FIG. 2 is a diagram illustrating a configuration diagram of a server for matching a talented person with a project according to exemplary embodiments of the present disclosure.

Disclosed is a server 100 according to exemplary embodiments of the present disclosure.

The server 100 according to exemplary embodiments of the present disclosure may include a transceiving unit 110, a network unit 120, a memory unit 130, and a control unit 140. The above-described configurations of FIG. 2 are exemplary and the scope of the present disclosure is not limited thereto. Hereinafter, components of the server 100 according to exemplary embodiments of the present disclosure will be described below in sequence.

The server 100 according to exemplary embodiments of the present disclosure may include the transceiving unit 110. The transceiving unit 110 may transmit/receive various information exchanged with the user device 200 and/or other servers in the course of providing a method of recommending the talented person according to exemplary embodiments of the present disclosure.

The transceiving unit 110 according to exemplary embodiments of the present disclosure may receive the profile information of the first user. In addition, the transceiving unit 110 may receive the project information for the project of the second user. Further, the transceiving unit 110 may receive a feedback on the project from the first user and receive the feedback for the first user from the second user.

According to an exemplary embodiment of the present disclosure, the network unit 120 may transmit the information acquired by the transceiving unit 110 to the user device 200 and/or the server 100. The network unit 120 may include a wired/wireless Internet module for network access. As the wireless Internet technology, wireless LAN (WLAN) (Wi-Fi), wireless broadband (Wibro), world interoperability for microwave access (Wimax), high speed downlink packet access (HSDPA), or the like, may be used. As wired Internet technology, a digital subscriber line (XDSL), fibers to the home (FTTH), power line communication (PLC), or the like may be used.

The network unit 120 includes the short range communication module to transmit/receive data to/from an electronic device which is positioned at a comparatively short range from the server 100 and includes the short range communication module. As short-range communication technology, Bluetooth, radio frequency identification (RFID), infrared data association (IrDA), ultra wideband (UWB), ZigBee, or the like may be used.

In an exemplary embodiment of the present disclosure, the network unit 120 may sense a connection state of the network and transmission and reception speeds of the network. The data received through the network unit 120 may be output through the display unit of the user device 200 or stored through the memory unit 130 or transmitted to other electronic apparatuses positioned in a short range through the short-range communication module.

The memory unit 130 according to exemplary embodiments of the present disclosure may store a program for a motion of the controller 140 therein and temporarily or persistently store input/output data (e.g., profile information, project information, keyword information for determining the keyword, etc.). The memory unit 130 may store data regarding the display and the sound.

The memory unit 130 according to exemplary embodiments of the present disclosure may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

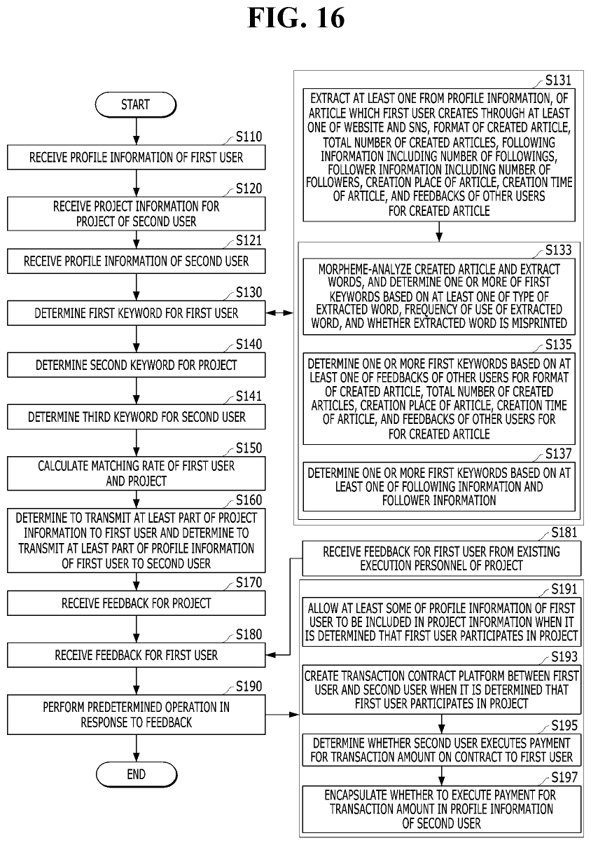

The memory unit 130 according to exemplary embodiments of the present disclosure may store various information, rules, and commands for matching the talented person with the project. This will be described below with reference to FIGS. 16 to 21. The memory unit 130 according to exemplary embodiments of the present disclosure may store a program, software, a command, a code, and the like for executing the server 100 and/or the user device 200. The memory unit 130 according to exemplary embodiments of the present disclosure may temporarily store data including a cache and temporarily store a program, a command, and the like required for operating the server 100 and/or the user device 200a.

The memory unit 130 according to exemplary embodiments of the present disclosure may include: a command of receiving profile information of a first user; a command of receiving project information for a project of a second user; a command of determining one or more first keywords for the first user from the profile information; a command of determining one or more second keywords for the projector information; a command of calculating a matching rate of the projector with the first user at least partially based on the one or more first keywords and the one or more second keywords; a command of determining to transmit at least of a part of the project information to the first user and determining to transmit at least a part of the profile information of the first user to the second user when the matching rate of the projector information and the first user exceeds a threshold matching rate; a command of receiving a feedback for the projector from the first user; a command of receiving a feedback for the first user from the second user; and a command of determining to perform a predetermined operation in response to the feedback when an intention of the feedback for the project matches the intention of the feedback for the first user.

The control unit 140 according to exemplary embodiments of the present disclosure may determine one or more first keywords for the first user from the profile information and determine one or more second keywords for the project information. An exemplary description as described above may be performed by a keyword determination unit 141 according to exemplary embodiments of the present disclosure.

The control unit 140 according to exemplary embodiments of the present disclosure may calculate the matching rate of the first user and the project at least partially based on the one or more first keywords and the one or more second keywords. An exemplary description as described above may be performed by a matching rate calculation unit 143 according to exemplary embodiments of the present disclosure.

When the matching rate of the project information and the first user exceeds the threshold matching rate, the control unit 140 may determine to transmit at least a part of the project information to the first user. The control unit 140 according to exemplary embodiments of the present disclosure may determine to transmit at least a part of the profile information of the first user to the second user. An exemplary description as described above may be performed by an information transmission determination unit 145 according to exemplary embodiments of the present disclosure.

The control unit 140 may determine to perform the predetermined operation corresponding to the feedback when the intention of the feedback for the project matches the intention of the feedback for the first user. An exemplary description as described above may be performed by an operation performing determination unit 147 according to exemplary embodiments of the present disclosure.

The above-described components of FIG. 2 are exemplary and the scope of the present disclosure is not limited thereto. As an example, the server 100 may further include an interface creation unit 149. Steps S210 to S250 described below may be performed by the interface creation unit 149 according to exemplary embodiments of the present disclosure. In other words, the interface creation unit 149 according to exemplary embodiments of the present disclosure may create an interface including various information displayed on the user device 200.

The server 100 according to exemplary embodiments of the present disclosure may be configured only by some components of the components described above. The server 100 may be used by communicating with an external server and include a server in itself. Further, some of the components of FIG. 2 described above may be integrated. For example, some components of the keyword determination unit 141, the matching rate calculation unit 143, the information transmission determination unit 145, the operation performing determination unit 147 and the interface creation unit 149 may be integrated into the control unit 140.

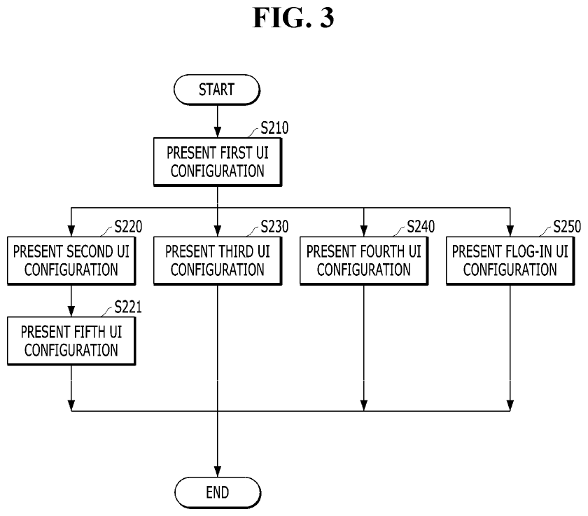

FIG. 3 is a diagram illustrating a flowchart of creating a user interface for matching a talented person with a project according to exemplary embodiments of the present disclosure.

FIG. 3 is presented to be performed by the server 100 according to exemplary embodiments of the present disclosure, but the scope of the present disclosure is not limited thereto. That is, steps illustrated in FIG. 3 may be performed by the server 100 or the user device 200 or a combination thereof. Further, each step described in FIG. 3 may be just an exemplary method for matching the talented person and the project and an order of each step may be changed and/or integrated. Further, additional steps may be implemented in addition to respective illustrated steps.

Referring to FIG. 3, a process for matching the talented person and the project will be described.

According to exemplary embodiments of the present disclosure, the server 100 may allow a first UI configuration for allowing selection of one of a plurality of indications presented onto the user device 200 to be automatically presented (S210).

FIG. 4 is an exemplary diagram of a user interface which may be presented onto a user device according to exemplary embodiments of the present disclosure.

In FIG. 4, an exemplary diagram of a first UI configuration 400 for allowing selection one of a plurality of indications presented onto the user device is presented.

The first UI configuration 400 illustrated in FIG. 4 is automatically presented on the user device in response to the program execution request according to exemplary embodiments of the present disclosure. Here, the first UI configuration 400 includes a first indication 401 for receiving profile information of a user, a second indication 403 for receiving project information for the project of the user, and a third indication 405 for providing information related to a project matching rate, and the scope of the present disclosure is not limited thereto. Types, names, functions, and shapes of the indications illustrated in FIG. 4 are only examples according to exemplary embodiments of the present disclosure, and various types, names, and functions may be included in the present disclosure.

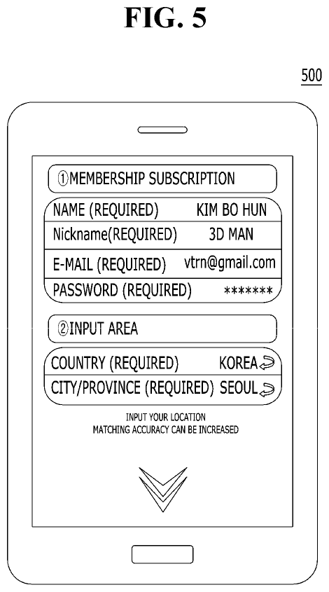

Referring back to FIG. 3, in response to the selection (e.g., a touch input of the user for the first indication) of the first display 401 (see FIG. 4) displayed on the user device 200, the server 100 may automatically present the second UI configuration for receiving the profile information from the user on the user device 200 (S220). This will be described below with reference to FIGS. 5 to 8.

FIGS. 5 to 8 are exemplary diagrams of a user interface which may be presented onto a user device according to exemplary embodiments of the present disclosure.

FIGS. 5 to 8 present exemplary diagrams of second UI configurations 500, 600, 700, and 800 for receiving the profile information from the user presented on the user device.

According to exemplary embodiments of the present disclosure, the second UI configurations 500, 600, 700, and 800 for receiving the profile information from the user are presented on the user device in response to the selection of the first indication 401 included in the first UI configuration 400 illustrated in FIG. 4.

The profile information according to exemplary embodiments of the present disclosure includes at least one of name information, ID information, gender information, age information, nationality information, education information, residence information, interested word information, possessed qualification information, other career information, website usage history information, and SNS information and the scope of the present disclosure is not limited thereto.

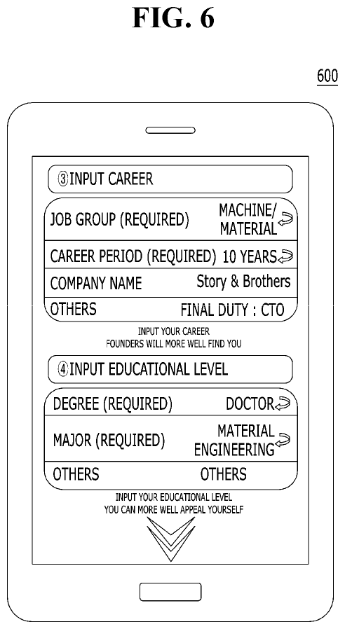

In the second UI configuration 500, 600, 700, and 800 according to exemplary embodiments of the present disclosure, required input items and optional input items for the profile information may be displayed separately. In this regard, referring to FIG. 6, in the second UI configuration 600, a “job group (required)” is displayed in a jog group, but “required” is not displayed in a company name and the “company name” is displayed, and as a result, it is presented to be visually confirmed that the company name is the optional input item. Alternatively, a shape of a tab for receiving the required input item among tabs receiving the profile information may be provided to be graphically rendered to emphasize the intuitiveness so as to enable the user to confirm that the user needs to perform an input. The aforementioned examples are exemplary descriptions for describing the exemplary embodiments of the present disclosure and the scope of the present disclosure is not limited thereto.

Information for guiding the user input of the optional input item may be presented to be displayed in the second UI configurations 500, 600, 700, and 800. Referring to FIG. 5, in the second UI configuration 500, information that “Enter your area, which can increase matching accuracy.” is displayed. Referring to FIG. 6, in the second UI configuration 600, information that “Enter your educational level, which can appeal to yourself better.” is displayed. Such information may guide the user input of the optional input item and may also include a description of the required input item.

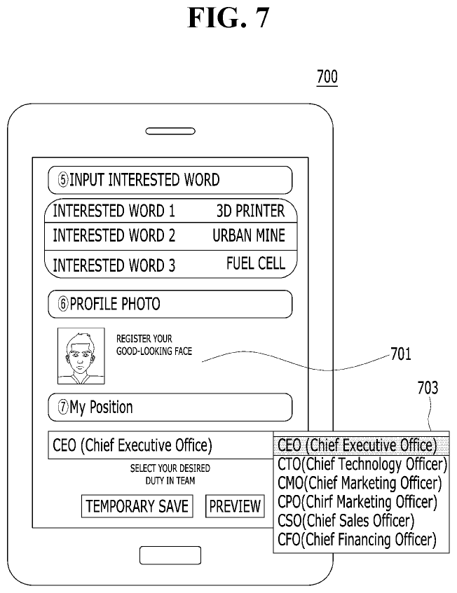

The second UI configuration 700 (see FIG. 7) according to exemplary embodiments of the present disclosure may include a sixth UI configuration 701 for obtaining information of at least some of the profile information through at least one of the memory and the network. Referring to FIG. 7, according to exemplary embodiments of the present disclosure, the sixth UI configuration 701 allows at least some of the profile information to be obtained from the user through at least one of the memory and the network. For example, in response to the selection for the sixth UI configuration 701, photo information stored in the memory of the server 100 and/or the user device 200 may be obtained.

The second UI configuration 700 (see FIG. 7) according to exemplary embodiments of the present disclosure may include a seventh UI configuration 705 for presenting profile sub information in order to obtain at least some of the profile information.

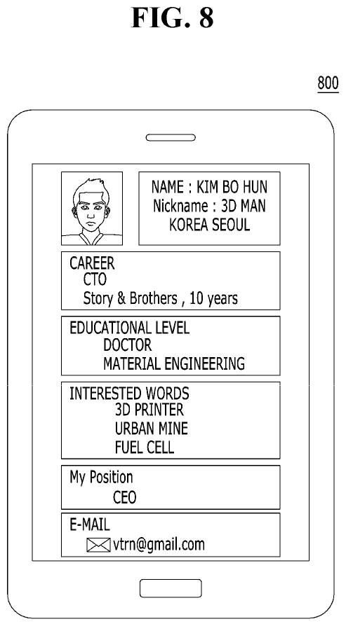

According to exemplary embodiments of the present disclosure, in response to a user selection input for the profile sub information presented in the seventh UI configuration 703 (see FIG. 7), the selected profile sub information may be determined as the profile information for the user. For example, in FIG. 7, as the profile sub information, the seventh UI configuration 703 including “CEO, CTO, CMO, CPO, CSO, and CFO” which are sub information for “My Position” is presented and this does not limit the scope of the present disclosure. In response to an optional input for “CEO” among the profile sub information presented in the seventh UI configuration 703, the “CEO” is included in the profile information of the user. This will be described with reference to a user interface 800 of FIG. 8.

The descriptions, the names, the functions, the shapes, and the like illustrated in FIGS. 5 to 8 are only examples according to exemplary embodiments of the present disclosure, and do not limit the scope of the present disclosure.

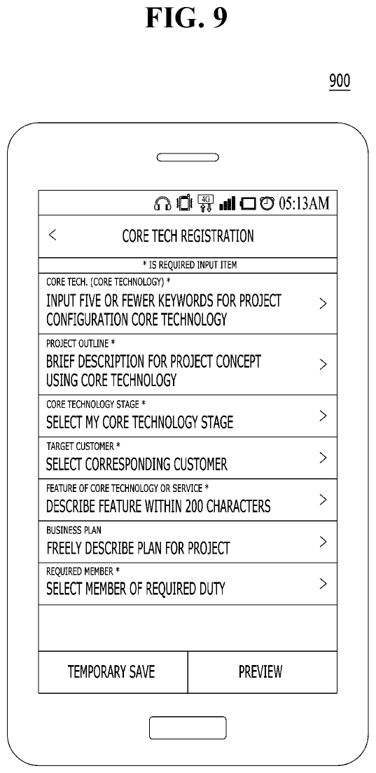

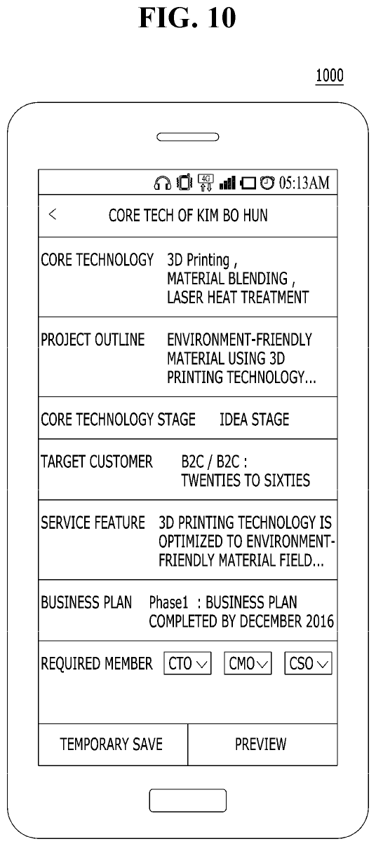

Referring back to FIG. 3, according to exemplary embodiments of the present disclosure, in response to the selection of the second indication displayed in the user device 200, the server 100 may automatically present the third UI configuration for receiving the project information from the user on the user device (S230). This will be described below with reference to FIGS. 9 and 10.

FIGS. 9 and 10 are exemplary diagrams of a user interface which may be presented onto a user device according to exemplary embodiments of the present disclosure.

FIGS. 9 and 10 present exemplary diagrams of the third UI configuration 900 for receiving the project information from the user presented on the user device and a UI 1000 including input information, which correspond to the third UI configuration 900.

According to exemplary embodiments of the present disclosure, the third UI configuration 900 for receiving the project information from the user is presented on the user device in response to the selection of the second indication 403 included in the first UI configuration 400 illustrated in FIG. 4.

The project information according to exemplary embodiments of the present disclosure includes at least one of core technology information, project outline information, core technology stage information of the project, project execution period information, and information on execution personnel required for the project, which includes at least one of information on the number of execution personnel and job group information of the execution personnel and the scope of the present disclosure is not limited thereto. For example, as presented in the third UI configuration 900, at least one of “target consumer” and “business plan” may be included in the project information.

The third UI configuration according to exemplary embodiments of the present disclosure may be presented to separately display the required input item and the optional input item for the projector information and display information for guiding the user input of the optional input item.

The third UI configuration according to exemplary embodiments of the present disclosure may include a sixth UI configuration for obtaining at least some of the project information through at least one of the memory and the network.

The third UI configuration according to exemplary embodiments of the present disclosure may include an eighth UI configuration for presenting the project sub information in order to obtain at least some of the project information. According to exemplary embodiments of the present disclosure, in response to a user optional input (e.g., a mouse click input at a location corresponding to the project sub information) for the project sub information presented in the eighth UI configuration, the selected project sub information may be determined as the project information for the user.

The project sub information will be described in more detail with reference to the third UI configuration 900 presented in FIG. 9. The core technology information may be input as a keyword for a project configuration core technology. For example, 3D printing and material blending may be input as the keyword for the core technology of the project. A push alarm may be provided to the first user who registers an interested word related to the keyword.

It is illustrated that the third UI configuration 900 illustrated in FIG. 9 guides inputting five or fewer keywords, but the scope of the present disclosure is not limited thereto. The number of keywords for the project configuration core technology which is input-acceptable may be adjusted considering a matching rate between the project and the project execution personnel and a satisfaction thereof.

A project outline according to exemplary embodiments of the present disclosure may include a description of a project concept using the core technology. The project outline may be directly input from the user, for example or input by obtaining text information and/or moving picture information prestored through the memory or the network.

A core technology stage according to exemplary embodiments of the present disclosure may be input as selection of at least one of an IDEA stage, a business plan establishment stage, a Minimum Viable Product phase, and a paid customer securing stage. The IDEA stage, the business plan establishment stage, the Minimum Viable Product stage, and the paid customer securing stage may be examples of the project sub information for the project information. The IDEA stage, the business plan establishment stage, the Minimum Viable Product phase, and the paid customer securing stage may be optionally input from the second user or may be determined by an external evaluation.

The project execution period information may mean information on a period during which the project is executed or during which the project is to be carried out. Furthermore, the information on the performance personnel required for the project may include at least one of the number of execution personnel and the job group information of the execution personnel. The number of execution personnel and the job group information of the execution personnel may include the number of execution personnel which already participates in the project and the job group information of the execution personnel. Alternatively, the number of execution personnel and the job group information of the execution personnel may include the number of execution personnel and the job group information of the execution personnel and the scope of the present disclosure is not limited thereto. Here, the job group information of the execution personnel may include, for example, R & D, marketing, planning, sales, accounting and the scope of the disclosure is not limited thereto.

As presented in FIG. 9, the third UI configuration 900 may be presented to further receive the target customer, the core technology or a feature of a service, the business plan, etc. The target customer may be each input based on a transaction type, for example. The transaction type includes, for example, B2B, B2C, C2C, and B2G. The target customer may be required to select at least one of age group and gender, and the scope of the present disclosure is not limited thereto. In the third UI configuration 900 according to exemplary embodiments of the present disclosure, it is indicated that the core technology or the feature of the service is described to be limited to 200 characters or less, but the scope of the present disclosure is not limited thereto.

The project information input through the above-described process refers to the UI configuration 1000 illustrated in FIG. 10. Therefore, the second user introduces a project carried out thereby to potential execution personnel (i.e., first user) to allow the first user to induce participate in the project.

The descriptions, the names, the functions, the shapes, and the like illustrated in FIGS. 9 and 10 are only examples according to exemplary embodiments of the present disclosure, and do not limit the scope of the present disclosure.

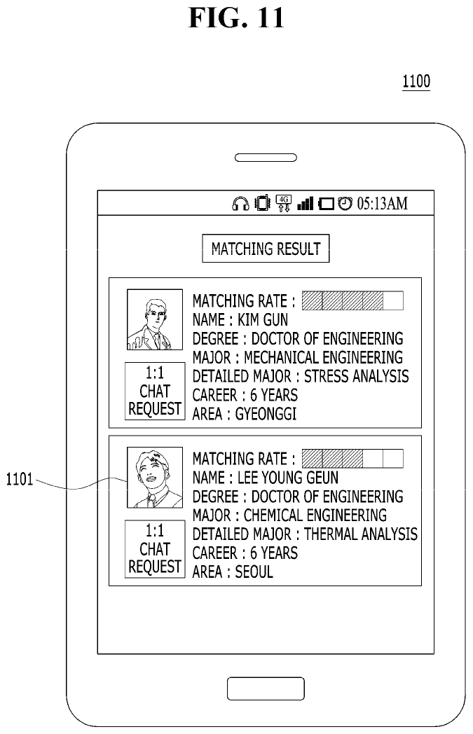

Referring back to FIG. 3, in response to selection of the third indication 405 (see FIG. 4) displayed in the user device 200, the server 100 may automatically present the fourth UI configuration on the user device, which indicates the matching rate of the project with the first user calculated at least partially based on one or more second keywords determined from the profile information of the first user and one or more second keywords determined from the project information of the second user. This will be described below with reference to FIG. 11.

FIG. 11 is an exemplary diagram of a user interface which may be presented onto a user device according to exemplary embodiments of the present disclosure.

According to exemplary embodiments of the present disclosure, in response to the selection of the third indication 405 included in the first UI configuration 400 illustrated in FIG. 4, a fourth UI configuration 1100 is presented on the user device, which indicates the matching rate of the project with the first user calculated at least partially based on one or more first keywords determined from the profile information of the first user and one or more second keywords determined form the project information of the second user.

Optionally or alternatively, the fourth UI configuration 1100 may further include an indication 1101 for providing a platform for transmitting/receiving predetermined information between the users, which may enhance convenience of the user.

The fourth UI configuration 1100 according to exemplary embodiments of the present disclosure may include a fifth indication for receiving the feedback for the project from the first user. For example, in response to the selection of the fifth indication displayed on the first user device 200a, at least one of the feedback information for the project of the first user and a portion of the profile information of the first user may be automatically presented on the second user device 200b. More specifically, when the first user inputs a feedback “interested” (for example, when a user input for an interested button is received, etc.), information that the first user is interested in the project may be displayed in the second user device 200b related to the project. The information may be delivered together with some of the profile information of the first user. The above-described contents are exemplary descriptions according to exemplary embodiments of the present disclosure and the scope of the present disclosure is not limited thereto.

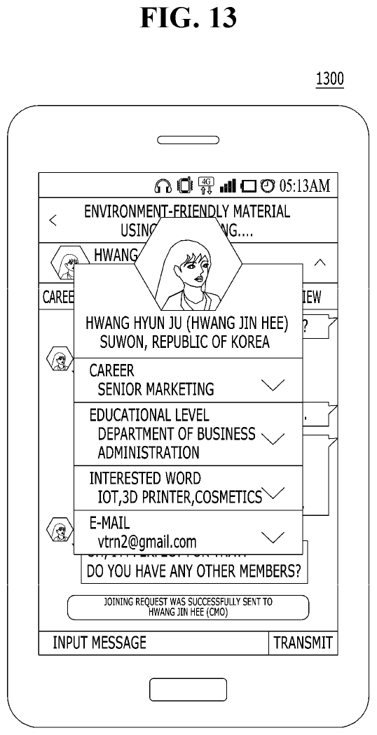

The fourth UI configuration 1100 according to exemplary embodiments of the present disclosure may include at least one of sixth indications for receiving the feedback for the first user from the second user. In response to selection of the sixth indication displayed, at least one of the feedback information of the second user for the first user and a portion of the project information may be automatically presented on the first user device. For example, in response to the selection of the sixth indication displayed on the second user device 200b, at least one of the feedback information of the second user for the first user and a portion of the project information may be automatically presented on the first user device. This will be described with reference to FIG. 13.

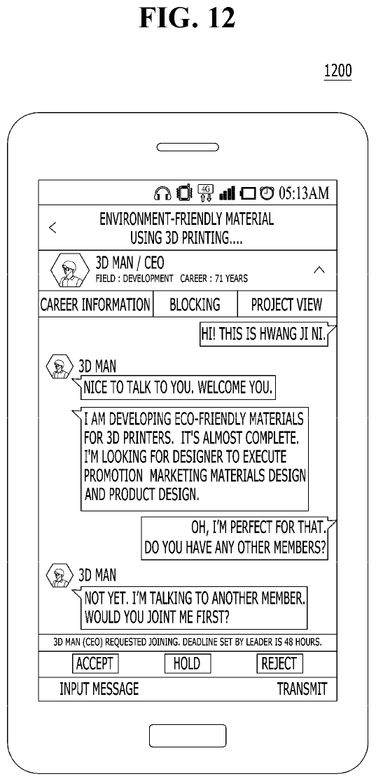

Referring back to step S210, the first UI configuration 400 according to exemplary embodiments of the present disclosure may further include a fourth indication 409 for providing a platform for transmitting/receiving predetermined information between the user of which matching rate with the project exceeds the threshold matching rate and another user related to the project. In response to the selection of the fourth indication 409 displayed in the user device 200, a fifth UI configuration 1200 (see FIG. 12) including at least one of a post upload platform, a chat platform, a messenger platform and a conference call platform may be automatically presented on the user device 200 (S221). The examples of the platforms are just exemplary descriptions according to exemplary embodiments of the present disclosure and the scope of the present disclosure is not limited thereto. The fifth UI configuration 1200 according to exemplary embodiments of the present disclosure will be described with reference to FIGS. 12 to 14.

FIGS. 12 to 14 are exemplary diagrams of a user interface which may be presented onto a user device according to exemplary embodiments of the present disclosure.

FIGS. 12 to 14 present exemplary diagrams of the fifth UI configuration 1200 presenting a platform for transmitting/receiving predetermined information between other users related to the project presented on the user device. In FIGS. 12 to 14, the chat platform is exemplified as the fifth UI configuration 1200, but the scope of the present disclosure is not limited thereto.

The fifth UI configurations 1200, 1300, and 1400 according to exemplary embodiments of the present disclosure may be presented as different types according to different rights determined based on at least one of the matching rate with the project, whether the user who exceeds the threshold matching rate participates in the project, and an execution task of the user who exceeds the threshold matching rate in the project. This will be described with reference to FIGS. 12 to 14.

FIGS. 12 and 13 illustrate fifth UI configurations 1200 and 300 that present the chat platform between the first user and the second user. The first user and the second user may confirm the profile information and/or the project information of the other party through the user interface illustrated in FIGS. 12 and 13 according to exemplary embodiments of the present disclosure. In addition, according to exemplary embodiments of the present disclosure, it is possible to perform a participation request and a participation acceptance of the project through the user interface illustrated in FIGS. 12 and 13. The above-described contents are just exemplary descriptions according to exemplary embodiments of the present disclosure and the scope of the present disclosure is not limited thereto.

As illustrated in FIG. 12, the first user or the second user may perform at least one of acceptance, holding, and rejection of the chat request. For example, the second user may propose a chat for the first user with a high matching rate, and the feedback to the first user for the proposal may be determined to be, for example, 48 hours. The contents illustrated and described in FIG. 12 are just exemplary descriptions according to exemplary embodiments of the present disclosure and the scope of the present disclosure is not limited thereto.

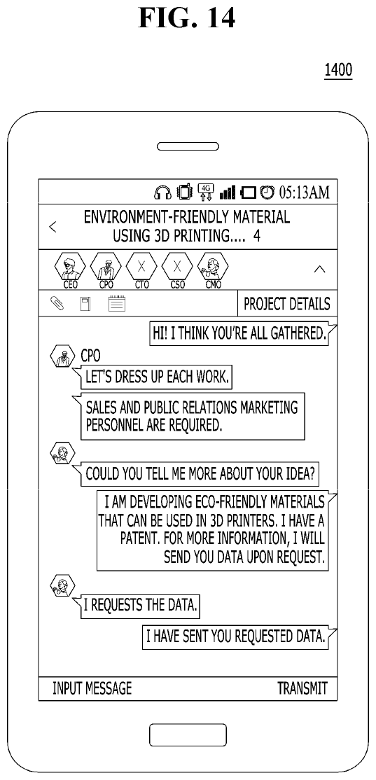

FIG. 14 illustrates a fifth UI configuration 1400 that presents a chat platform between execution personnel participating in the project. According to exemplary embodiments of the present disclosure, information required for performing the project is allowed to be transmitted/received or delivered through the chat platform.

Referring to FIG. 14, when it is determined that the first user participates in the project, a right to use the platform related to the project may be granted to the first user. In addition, the usage right, user, usage time, and usage details of the platform may be automatically recorded and stored. According to the above-described contents, each of the chat platforms opened in a predetermined project stores details, which allows the execution personnel of the project to check the details. Additionally, a schedule platform, an alarm platform, and a note platform required for executing the project may be further provided.

According to the method for matching the talented person and the project according to exemplary embodiments of the present disclosure, various platforms may be provided, which may match execution personnel suitable for the project and enables a smooth project. As a result, convenience of the execution personnel performing the project and efficiency of the project are enhanced.

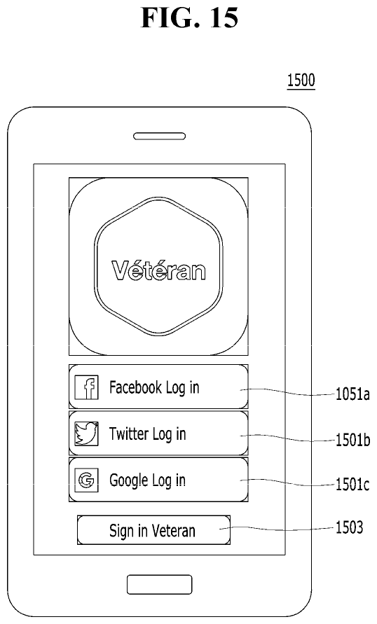

Referring back to FIG. 3, according to exemplary embodiments of the present disclosure, a login UI configuration for logging in to a program may be automatically presented on the user device by allowing selection of one of a plurality of indications presented on the user device 200 in response to a program execution request. This will be described with reference to FIG. 15.

FIG. 15 is an exemplary diagram of a user interface which may be presented onto a user device according to exemplary embodiments of the present disclosure.

FIG. 15 presents an exemplary diagram of a login UI configuration 1500 for logging in to the program.

According to exemplary embodiments of the present disclosure, in response to the selection of indications 1501a, 1501b, 1501c, and 1503 included in the login UI configuration 1500 illustrated in FIG. 15, UI configurations corresponding to respective indications may be presented on the user device.

The login UI configuration 1500 according to exemplary embodiments of the present disclosure may be configured to include seventh indications 1501a, 1501b, and 1501c for performing a login and an eighth indication 1503 for subscribing a membership of the user for the program as illustrated in FIG. 15.

Here, the login may be performed partially based on at least one of a portion of the profile information of the user and biometrics information of the user. The above-described biometrics information may include at least one of a signature, a face, an iris, a retina, a fingerprint, a voice, a hand shape, and a hand blood vessel.

Biometrics may be defined as determining an identification by automatically measuring body or behavioral characteristics. A recognition of a person based on observation of behavioral and biological (anatomical and physiological) features may be defined as the biometrics. According to an additional exemplary embodiment, the login may be performed based on SNS information of the user. In FIG. 15, it is illustrated that the login is performed based on the SNS information of the user, but the scope of the present disclosure is not limited thereto.

FIG. 16 is a diagram illustrating a flowchart of a method for matching a talented person with a project according to exemplary embodiments of the present disclosure.

Referring to FIG. 16, a process for matching the talented person and the project will be described.

FIG. 16 is presented to be performed by the server 100 according to exemplary embodiments of the present disclosure, but optionally or alternatively, may be performed by the user device 200. Further, some of respective steps described below may be performed by the server 100 or other some may be performed by the user device 200 and the scope of the present disclosure is not limited thereto.

Referring to FIG. 16, the profile information of the first user may be received (S110).

As described above, the profile information includes at least one of name information, ID information, gender information, age information, nationality information, education information, residence information, interested word information, possessed qualification information, other career information, website usage history information, and SNS information and the scope of the present disclosure is not limited thereto.

According to exemplary embodiments of the present disclosure, the project information for the project of the second user may be received (S120).

As described above, the project information includes at least one of core technology information, project outline information, core technology stage information of the project, project execution period information, and information on execution personnel required for the project, which includes at least one of information on the number of execution personnel and job group information of the execution personnel and the scope of the present disclosure is not limited thereto.

According to exemplary embodiments of the present disclosure, the first keyword for the first user may be determined (S130).

First keyword information according to exemplary embodiments of the present disclosure may be at least some of the profile information. For example, interested word information received from the first user may be the first keyword information. The aforementioned disclosures are exemplary descriptions according to exemplary embodiments of the present disclosure and the scope of the present disclosure is not limited thereto.

According to exemplary embodiments of the present disclosure, at least one may be extracted of the profile information of the first user, of an article which the first user creates through at least one of the website and the SNS, a format of a created article, the total number of created articles, following information including the number of followings, follower information including the number of followers, a creation place of the article, a creation time of the article, and feedbacks of other users for the created article (S131).

According to exemplary embodiments of the present disclosure, the first keyword may be determined from at least one of the following steps (S133, S135, and S137) (S130).

In step 5133, the created article is morpheme analyzed and words are extracted, and one or more of the first keywords may be determined based on at least one of the type of the extracted word, the frequency of use of the extracted word, and whether the extracted word is misprinted (S133).

For example, when there are many terms related to wireless communication as the extracted words, a keyword of wireless communication may be determined for the first user. Alternatively, when the extracted words have a large number of internet phantoms, keywords such as “sensitive to fashion”, “plenty of Internet use”, and the like may be determined for the first user. Further, whether the extracted word is misprinted exceeds a predetermined threshold, keywords including “urgent personality”, promotion of work is fast”, ‘there is temperament as a leader”, “active”, and the like may be determined. The above-described disclosures are just exemplary contents according to exemplary embodiments of the present disclosure and the scope of the present disclosure is not limited thereto.

In step S135, one or more first keywords may be determined based on at least one of feedbacks of other users for the format of the created article, the total number of created articles, the creation place of the article, the creation time of the article, and feedbacks of other users for the created article (S135).

For example, when the majority of formats of the created article are short sentences, keywords including “urgent personality”, “clear”, and the like may be determined. On the contrary, when the majority of formats of the created article are long sentences, keywords including “deep consideration for opponent”, “good expressive power”, “suitable for HR”, and the like may be determined. When an external article link is frequent, keywords including “sensitive to news”, “good delivery power”, “suitable for planning work”, and the like may be determined. When a lot of travel photographs are taken and loaded, keywords such as “suitable for business”, “good self-expressiveness”, and “active” may be determined.

Additionally, when the feedback of the first user for an article created by another person or the feedback of the first user for feedbacks of other users for the created article is fast, keywords including “sincerity”, “suitable for role of medium of organization”, and the like may be determined. The above-described disclosures are just exemplary contents according to exemplary embodiments of the present disclosure and the scope of the present disclosure is not limited thereto.

According to exemplary embodiments of the present disclosure, one or more first keywords may be determined based on at least one of the following information and the follower information (S137).

When the number of followers is larger than the number of followings, keywords including “presence of leader temperament”, “excellent organization ability”, and the like may be determined. When there is no following and follower (or there are less followings and followers) and a predetermined follower loads only many articles thereof, keywords including “suitable for personal business” and the like may be determined. When there is no following and follower (or there are less followings and followers) and a predetermined follower does not load articles thereof, keywords including “busy”, “sensitive to security”, “suitable for finance, and the like may be determined. The above-described disclosures are just exemplary contents according to exemplary embodiments of the present disclosure and the scope of the present disclosure is not limited thereto.

That is, as seen in steps S133, S135, and S137, according to exemplary embodiments of the present disclosure, the keyword for the user may be determined through the propensity inference and/or association inference. For example, the keyword for the user may be determined through at least one algorithm of linguistic inference, spatial inference, and propensity inference. To this end, inference logic may be predetermined and stored in the memory and the inference logic may be learned at least partially based on the user feedback.

According to exemplary embodiments of the present disclosure, the second keyword for the project may be determined (S140).

The second keyword information for the project may be determined at least partially based on the project information received by step 5120. Optionally or alternatively, the second keyword information according to exemplary embodiments of the present disclosure may be at least some of the project information. For example, the number of required execution personnel and the job group information received from the second user may be the second keyword information. The aforementioned disclosures are exemplary descriptions according to exemplary embodiments of the present disclosure and the scope of the present disclosure is not limited thereto.

According to exemplary embodiments of the present disclosure, the matching rate of the first user and the project may be calculated (S150). When the matching rate of the project information calculated by step S150 and the first user exceeds the threshold matching rate, it may be determined that at least some of the project information is to be transmitted to the first user and it may be determined that at least some of the profile information of the first user is to be transmitted to the second user (S160). As a result, information for matching a project in which the first user (talented person) is expected to be interested may be provided. Further, information on a first user (talented person) with a carrier, which is expected to be required for the second user (project establisher) may be provided.

The threshold matching rate according to exemplary embodiments of the present disclosure may be determined at least partially based on the project information. For example, the threshold matching rate may be differently determined at least partially based on a project budget scale. As another example, the threshold matching rate may be differently determined at least partially based on project core technology information. More specifically, when core technology stage information corresponds to the “IDEA” stage, the threshold matching rate may be set to be lower than the “paid customer securing stage”. The above-described examples are exemplary descriptions according to exemplary embodiments of the present disclosure and the scope of the present disclosure is not limited thereto.

According to exemplary embodiments of the present disclosure, some of the profile information of the first user to be transmitted to the second user may be determined based on at least one of a period to which the matching rate calculated by step S150 belongs and an open allowance range of the profile information of the first user received from the first user.

According to exemplary embodiments of the present disclosure, at least some of the project information to be transmitted to the first user may be determined based on at least one of the period to which the matching rate calculated by step S150 belongs and an open allowance range of the profile information of the second user received from the second user.

Referring back to FIG. 11, it is illustrated that user “Kim Gun” is higher in matching rate with the project than user “Lee Young-geun”. In this case, a range of the project information which may be received by the user Kim Gun may be wider than the range of the project information which may be received by the user Lee Young-geun. Further, the open allowance range of the profile information of the user or the project information may be determined by user selection.

Optionally or alternatively, a transmission scheme of at least one of some of the profile information of the first user and some of the project information for transmission may be determined at least partially based on the period to which the matching rate calculated by step S150 belongs. For example, when the matching rate belongs to a period of 0 to 30%, the transmission scheme may adopt e-mail, but when the matching rate belongs to a period of 90 to 100%, the transmission scheme may adopt a combination of “SMS and pop-up notification” schemes. According to exemplary embodiments of the present disclosure, when the matching rate of the talented person and the project is high, information may be more positively and directly provided. Accordingly, an effect that more opportunities in which the talented person may participate in the project may be provided is presented.

According to exemplary embodiments of the present disclosure, the feedback for the project may be received from the first user (S170). According to exemplary embodiments of the present disclosure, the feedback for the first user may be received from the second user (S180).

The “feedback” which is the term used in steps S170 and S180 may mean “whether to participate in project”. Optionally or alternatively, the “feedback” may mean “whether to be interested in project”.

According to exemplary embodiments of the present disclosure, a predetermined operation may be performed in response to the feedback (S190). More specifically, it may be determined that the predetermined operation is to be performed in response to the feedback when the intention of the feedback for the project matches the intention of the feedback for the first user.

According to exemplary embodiments of the present disclosure, when the intention of feedback for the project from the first user received through steps S170 through S180 and the intention of the feedback from the second user to the first user match each other as “project common progress”, a predetermined platform capable of transmitting/receiving various information may be provided to the first user and the second user. The above-described predetermined platform may be, for example, the chat platform and the scope of the present disclosure is not limited thereto. In this regard, FIGS. 12 and 13 illustrate the chat platform as an example.

According to exemplary embodiments of the present disclosure, step S180 may be determined by receiving the feedback for the first user from the existing execution personnel of the project (S181) and at least partially based on the feedback for the first user received from the existing execution personnel. Therefore, the intentions of other personnel performing the project together may also be considered in addition to the intention of the project establisher.

According to exemplary embodiments of the present disclosure, when it is determined that the first user participates in the project, a right to use the platform related to the project may be granted to the first user. Such a platform may include at least one of a post upload platform, a chat platform, a messenger platform, and a conference call platform, and the scope of the present disclosure is not limited thereto. In this regard, in FIG. 14, the chat platform is illustrated as an example.

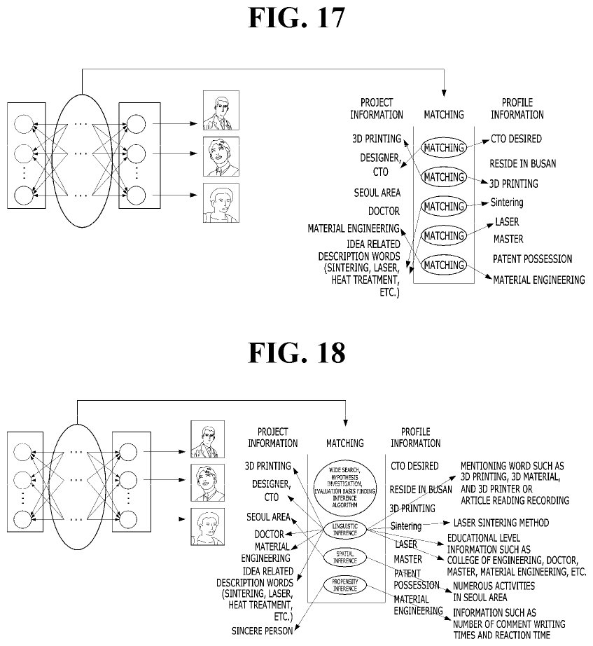

The first user (talented person) and the second user (project establisher) may be matched according to the method of matching the talented person and the project including steps S110 to S190 as described above. This will be described with reference to FIG. 17.

FIG. 17 is a first conceptual view of a method for matching a talented person with a project according to exemplary embodiments of the present disclosure. The disclosure illustrated in FIG. 17 is a diagram acquired by schematically illustrating steps S110 to S190 of the present disclosure and the scope of the present disclosure is not limited thereto.

Referring back to step S110, the profile information may further include information on the first user opened on the Internet. In order to find the information on the first user opened on the Internet, an artificial intelligence (AI) may be used. This will be described with reference to FIG. 18.

FIG. 18 is a second conceptual view of a method for matching a talented person with a project according to exemplary embodiments of the present disclosure.

In the method for matching the talented person and the project according to exemplary embodiments of the present disclosure, based on name information received from the first user, the information opened on the Internet in response to the name information may be determined as the profile information for the first user. As another exemplary embodiment, based on residence information received from the first user, the information opened on the Internet in response to the residence information may be determined as the profile information for the first user. More specifically, when the first user lives in “Seoul”, key words determined based on the information (e.g., residence classification, etc.) opened on the Internet for “Seoul” may be determined as the profile information for the first user. For example, since “Seoul” corresponds to “metropolitan city”, a key word determined based on “metropolitan city”, for example, “sensitive to fashion” may be determined as the profile information for the first user.

According to exemplary embodiments of the present disclosure, the information on the first user opened on the Internet may be found by using the artificial intelligence (AI). The keyword for the user may be determined from the information on the first user opened on the Internet through the propensity inference and/or association inference. For example, the keyword for the user may be determined through at least one algorithm of linguistic inference, spatial inference, and propensity inference. To this end, inference logic may be predetermined and stored in the memory and the inference logic may be learned at least partially based on the user feedback.

Referring back to FIG. 16 and by returning to step S140, according to exemplary embodiments of the present disclosure, a third keyword for the second user may be determined (S141). That is, one or more third keywords for the second user may be obtained from the profile information of the second user through step S141. Before step S141, the profile information of the second user may be received (S121). Step S121 may be performed together with step S120, for example. According to exemplary embodiments of the present disclosure, the matching rate of the first user and the project may be calculated additionally based on the third keyword. As a result, the matching rate may be calculated even by considering the propensity of the establisher who establishes the project in addition to the projection information of the project.

According to exemplary embodiments of the present disclosure, the method for matching the talented person with the project may further include step S191 of allowing at least some of the profile information of the first user to be included in the project information when it is determined that the first user participates in the project. Accordingly, the project information may further include at least some of the profile information of the project execution personnel. According to exemplary embodiments of the present disclosure as described above, a talented person suitable for the project may be matched, taking into account all of the project, the establisher of the project, and the project execution personnel or at least one thereof.

According to exemplary embodiments of the present disclosure, the method for matching the talented person with the project may further include step S193 of creating a transaction contract platform between the first user and the second user when it is determined that the first user participates in the project. Further, the method for matching the talented person with the project may include determining whether the second user executes payment for a transaction amount on the contract to the first user (S195) and encapsulating whether to execute the payment for the transaction amount in the profile information of the second user (S197). The method for matching the talented person with the project according to exemplary embodiments of the present disclosure may provide a platform that may solve various requests accompanied even by the contract after project establishment, project progress, and project termination in addition to allowing the project to be performed by matching a talented person having a talent to participate in the project without an idea with a project establisher who may not perform a new business because the project establisher has the idea but does not have a teamwork.

Each step presented in FIG. 16 is just an exemplary method for matching the talented person and the project and an order of each step may be changed and/or integrated. Further, additional steps may be implemented in addition to respective illustrated steps.

As an example, according to exemplary embodiments of the present disclosure, the method for matching the talented person with the project may further include determining a third user of which matching rate with the project information is high from one of the profile information of the first user and the profile information of the second user and determining to transmit information for recommending the determined third user to the second user. Therefore, an opportunity may occur in which the third user who does not use a program for providing the method for matching the talented person with the project may also participate in the project.

The third user according to exemplary embodiments of the present disclosure may be determined at least partially based on at least one of the SNS information of the first user and the SNS information of the second user.

Here, the SNS information of the user may include at least one of SNS account information including user identification information, SNS activity history information including an SNS post created by the user and a comment created by the user, reaction information of another user for at least one of the SNS post created by the user and the comment created by the user, following information including following account information corresponding to following by the SNS account information and the number of followings, and follower information including follower account information corresponding to a follower for the SNS account information and the number of followers and the scope of the present disclosure is not limited thereto.

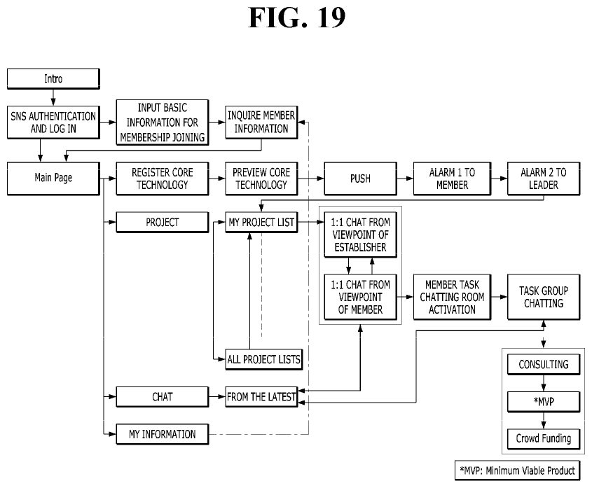

FIG. 19 illustrates an operation conceptual view of an application for providing an exemplary method for matching a talented person with a project according to exemplary embodiments of the present disclosure.

An exemplary method for matching the talented person with the project according to exemplary embodiments of the present disclosure described through FIGS. 1 to 18 performs an operation illustrated in FIG. 19. Contents illustrated in FIG. 19 is just an example of the method for matching the talented person with the project according to exemplary embodiments of the present disclosure and it will be apparently appreciated to those skilled in the art that the scope of the present disclosure is not limited to FIG. 19.

According to exemplary embodiments of the present disclosure, a talented person and a project optimized may be matched with each other by an efficient scheme.

According to exemplary embodiments of the present disclosure, project information with a high matching rate may be provided to the talented person and talented person information with a high matching rate may be provided to the project establisher.

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific function, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer readable device. The media may include storage media or communication media. For example, a computer readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto.

The communication media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the communication media include wired media such as a wired network or a direct-wired connection and wireless media such as acoustic, RF, infrared and other wireless media.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

What is claimed is:

1. A computer program stored in a non-transitory computer readable medium, wherein the computer program includes commands which cause one or more processors of a computer system to execute steps, the steps comprising:
presenting on a user device a first user interface (UI) configuration for allowing a selection of one of a plurality of indications presented on the user device in response to a program execution request, wherein the first UI configuration includes a first indication for receiving profile information of a user, a second indication for receiving project information for a project of a user and a third indication for providing information relating to a project matching rate;
presenting on the user device a second UI configuration for receiving the profile information from the user in response to a selection of the first indication;
presenting on the user device a third UI configuration for receiving the project information from the user in response to a selection of the second indication; and
presenting on the user device a fourth UI configuration for displaying a matching rate between a first user and the project in response to a selection of the third indication, wherein the matching rate is calculated based at least in part on one or more first keywords determined from profile information of a first user and one or more second keywords determined from project information of a second user.

2. The computer program of claim 1, wherein the first UI configuration further comprises a fourth indication for providing a platform for transmitting and receiving information between a user whose matching rate with the project exceeds a threshold matching rate and another user related to the project,
wherein the steps further comprise:
presenting a fifth UI configuration on the user device in response to a selection of the fourth indication, the fifth UI configuration including at least one of a post upload platform, a chat platform, a messenger platform or a conference call platform.

3. The computer program of claim 2, wherein the fifth UI configuration is presented in a different format according to different authority determined based on at least one of the matching rate with the project, a participation of a user in the project exceeding the threshold matching rate or performing task in the project of a user exceeding the threshold matching rate.

4. The computer program of claim 1, wherein the second UI configuration and the third UI configuration display a required input item and a selected input item for the profile information and the project information separately and display information that induces user input to the selected input item,
wherein the profile information comprises at least one of name information, ID information, gender information, age information, nationality information, education information, residence information, interested language information, retention qualification information, history information, website usage information or social network system information, and
wherein the project information comprises at least one of core technology information, project outline information, core technology level information of the project, project execution period information or information about a performance personnel required for the project including at least one of a number of the performance personnel and a performance group information of the performance personnel.

5. The computer program of claim 1, wherein the second UI configuration and the third UI configuration comprise a sixth UI configuration for obtaining at least a portion of the profile information and the project information via at least one of a memory and a network.

6. The computer program of claim 1, wherein the second UI configuration and the third UI configuration comprise a seventh UI configuration for presenting profile sub information to obtain at least a portion of the profile information and the project information and an eighth UI configuration for presenting project sub information, and
wherein the steps further comprise:
determining, as the profile information for the user, a selected profile sub information in response to a user selection input for the profile sub information presented in the seventh UI configuration; and
determining, as the project information for the user, a selected project sub information in response to a user selection input for project sub information presented in the eighth UI configuration.

7. The computer program of claim 1, wherein the fourth UI configuration comprises a fifth indication for receiving feedback on the project from the first user,
wherein the steps further comprise:
presenting at least one of feedback information for the project of the first user or a portion of the profile information of the first user on a device of the second user.

8. The computer program of claim 1, wherein the fourth UI configuration comprises a sixth indication for receiving feedback for the first user from the second user, and
wherein the steps further comprise:
presenting at least one of feedback information for the first user of the second user or a portion of the project information on a device of the first user in response to a selection of the sixth indication.

9. The computer program of claim 1, wherein the steps comprise:
presenting on the user device a login UI configuration for logging into a program by allowing selection of one of a plurality of indications presented on the user device in response to a program execution request,
wherein the login UI configuration comprises a seventh indication for performing a login and an eighth indication for a user's subscription to the program, and
wherein the login is performed based in part on at least one of a portion of a user's profile information and biometric information of the user.

10. A user device, comprising:
at least one display unit;
at least one processor; and
a memory configured to store instructions executable by the processor;
wherein the at least one processor is further configured to:
present on a user device a first UI configuration for allowing a selection of one of a plurality of indications presented on the user device in response to a program execution request, wherein the first UI configuration includes a first indication for receiving profile information of a user, a second indication for receiving project information for a project of the user and a third indication for providing information relating to a project matching rate;
present on the user device a second UI configuration for receiving the profile information from the user in response to a selection of the first indication;
present on the user device a third UI configuration for receiving the project information from the user in response to a selection of the second indication; and
present on the user device a fourth UI configuration for displaying a matching rate between a first user and the project in response to a selection of the third indication, wherein the matching rate is calculated based at least in part on one or more first keywords determined from the profile information of a first user and one or more second keywords determined from the project information of a second user.
